(19) United States
(12) Patent Application Publication
(10) Pub. No.: US 2009/0205764 A1
(43) Pub. Date: Aug. 20, 2009

(54) TIRE INFLATION SYSTEM

(75) Inventor: Ralf Pionke, Farmington Hills, MI (US)

Correspondence Address: BAKER & DANIELS LLP, 202 South Michigan Street, Suite 1400, South Bend, IN, 46601, US

(73) Assignee: AM GENERAL LLC, South Bend, IN (US)

(21) Appl. No.: 12/031,773

(22) Filed: Feb. 15, 2008

(51) Int. Cl. B60C 23/00

(52) U.S. Cl. 152/427

(57) ABSTRACT

A wheel assembly for connection to an onboard tire inflation device includes an inboard rim part, an outboard rim part, a rim base on at least one of the parts and a wheel mounting portion. The wheel mounting portion includes a first passageway extending from an inner opening in the wheel mounting portion to an opening in the rim base. An adapter is mounted to the wheel mounting portion of the wheel and extends at least partially into the inner opening of the wheel in one embodiment, the adapter includes second and third passageways, a circumferential groove in communication with the third passageway, and a valve seat. A valve is mounted to the valve seat. The adapter may include a spindle seat, and the other end of the second passageway opposite the valve seat terminates in an opening in the spindle seat. A seal member may be located in an annular groove formed in the spindle seat around the opening.

### BACKGROUND OF THE INVENTION

This invention pertains to a tire inflation system, and in particular to a tire inflation system having a valve assembly located in the central portion of the rim.

Typically, tubeless tires are mounted on a wheel such that a valve stem extends through a hole in the wheel for inflation of the tire from an external source. It has also been known to include a tire inflation device on a vehicle in order to have the ability to inflate the tire without an external source of air. Furthermore, it has been known to include tire inflation systems that permit the tire to be inflated while the vehicle is in motion. One such device is disclosed in U.S. Pat. No. 1,083,847 to McDowell et al. McDowell discloses a tire inflation system including a channel or passage through the axle of the vehicle. One end of the passage is connected to an air supply mounted on the frame of the vehicle, and the other end opens into the center of a ring mounted on the axle. The ring includes a circumferential groove located around the periphery thereof that provides a path for air to flow to another tube that is connected to a valve for inflating the tire.

Another tire inflation system is disclosed in U.S. Pat. No. 5,221,381 to Hurrell II. The system includes a wheel spindle 14 having a wheel mounting flange extending therefrom and an axial air passage through the center of the spindle. A bearing assembly is mounted about the spindle, and an inlet air hose is mounted to the bearing assembly in a manner to provide a pathway for air to flow from the inlet tube into the axial air passage of the spindle. The axial air passage opens into a plenum, which is in communication with a valve. The valve is connected to a radial passage in the wheel that leads to an outlet in the rim of the wheel for inflating the tires.

Another tire inflation system is disclosed in U.S. Pat. No. 5,429,167 to Jensen. In the Jensen system, communication is provided between a pressurized air reservoir through the axle tubes and through a spindle sleeve disposed on the end of each tube into a sealed chamber. The chamber is defined by the spindle hub, hub cover, rotary seal, and spindle sleeve. The seal carrier encloses the end of the axle, and at least one air passage is provided in the spindle hub which provides communication to the wheel valves. The control system includes a plurality of multi-port, two-way pneumatic valves.

Another tire inflation system is disclosed in U.S. Pat. No. 6,425,427 to Stech. The system in Stech provides pressurized air from an axle of a vehicle to rotating tires to maintain a desired pneumatic pressure. The air supply system is adapted to be disposed within the hollow axle of the vehicle. The system Includes an axle plug assembly with a slidable piston to facilitate adapting the device to vehicles having different axle lengths.

Another tire inflation system is disclosed in U.S. Patent Application Publication No. US 2005/0205182 A1 to Maquaire et at The system in Maquaire includes a wheel, a wheel hub supporting the wheel, and an inflating and deflating valve for supplying compressed air from a pressurized circuit. The valve is positioned between the wheel and the wheel hub and includes sealing means integrated into the wheel supply circuit. The sealing means is activated to an open position when the valve is mounted on the wheel rim, and when the wheel rim is dismounted, the sealing means goes to a closed position. The sealing means is located in the wheel, and a radial duct transfers air from a central portion of the wheel to the rim for inflating a tire mounted thereon.

### SUMMARY OF THE INVENTION

In one embodiment of the invention, a wheel assembly is provided for connection to an onboard tire inflation device. The wheel assembly includes a multiple part wheel having an inboard rim part with a rim base and an inboard tire bead retaining flange, and a removable outboard rim part having an outboard tire bead retaining flange. The inboard rim part has a wheel mounting portion and a first passageway extending therethrough from a central opening to the rim base. The wheel assembly also includes an adapter mounted to the wheel mounting portion of the inboard rim part and extending at least partially into the central opening in the wheel mounting portion. The adapter includes a second passageway and a third passageway. The wheel assembly also includes a valve assembly mounted to the adapter and in communication with the second passageway, and the valve is also in communication with the third passageway in the adapter.

The wheel assembly may also include a second valve that is mounted in a second opening in the wheel mounting portion of the inboard rim part. The second valve is in communication with the first passageway in the wheel mounting portion.

The adapter may have a circumferentially extending groove that is in communication with the third passageway in the adapter and with the first passageway in the wheel mounting portion of the inboard rim part. The adapter may also include first and second circumferential channels on opposite sides of the circumferential groove, and a resilient sealing member in each of the circumferential channels. The adapter may have a spindle seat that is oriented substantially parallel to the wheel mounting portion of the inboard rim part. The second passageway in the adapter may have an opening in the spindle seat, and the spindle seat may have an annular groove located therein with a sealing member located in the annular groove. The groove and the sealing member extend around an opening of the second passageway. A continuous airflow pathway is formed between the opening in the spindle seat and an opening of the first passageway in the rim base of the inboard rim part. The valve assembly mounted to the adapter allows air to flow from the opening in the spindle seat to the opening in the rim base; however, the valve assembly restricts airflow in the opposite direction.

The third passageway in the adapter may include an axial portion that terminates at an opening where the valve assembly is mounted to the adapter. The adapter may also include a mounting flange and an axial recess configured to receive the valve assembly. The continuous pathway extends through the wheel assembly regardless of the radial orientation in which the adapter is mounted relative to the wheel mounting part.

In another embodiment of the invention, a wheel assembly is provided for connection to an onboard tire inflation device, wherein the wheel assembly includes a wheel having a rim base, an inboard tire bead retaining flange, an outboard tire bead retaining flange, and a wheel mounting portion having a central opening and a first passageway therethrough. An adapter is mounted to the wheel mounting portion of the wheel and extends at least partially into the central opening. The adapter includes a second passageway and a third passageway, wherein the second passageway terminates in an opening through a spindle seat. The spindle seat is oriented substantially parallel to the wheel mounting portion of the wheel, and a valve is mounted to the adapter. The valve is in communication with the second passageway and the third passageway in the adapter.

The first passageway extends between the central opening and the rim base. A second valve may be mounted in an opening in the wheel mounting portion of the wheel, wherein the second valve extends into the first passageway in the wheel mounting portion.

The spindle seat on the adapter may have an annular groove located therein, and a sealing member is located in the annular groove that extends around the opening in the spindle seat. The adapter may also have a circumferential groove. The third passageway in the adapter may be in communication with the groove, and a pair of circumferential channels extend around the adapter, with one channel on each side of the groove. A sealing member is located in each channel. The passageways may form a continuous airflow pathway from the opening of the second passageway in the spindle seat of the adapter to an opening in the rim base at an end of the first passageway in the wheel mounting portion.

In another embodiment of the invention, a wheel assembly is provided for connection to an onboard tire inflation device, wherein the wheel assembly has a wheel including an inboard rim part and an outboard rim part, and the wheel further includes a rim base on at least one of the parts and a wheel mounting portion. The wheel mounting portion includes a first passageway extending from an inner opening in the wheel mounting portion to an opening in the rim base, and an adapter is mounted to the wheel mounting portion of the wheel and extends at least partially into the inner opening of the wheel. The adapter includes a second passageway, a third passageway, a circumferential groove in communication with the third passageway, and a valve seat, wherein the second passageway terminates in an opening. A valve is mounted to the valve seat.

The adapter may include a spindle seat, and the other end of the second passageway opposite the valve seat terminates in an opening in the spindle seat. The spindle seat may include a seal member in an annular groove around the opening.

The adapter may also include a mounting flange configured to mount the adapter to the wheel mounting portion of the wheel, and the flange may extend generally parallel with the wheel mounting portion of the wheel. The adapter may also include a recess with the valve seat at the bottom of the recess. The recess is open toward the outboard rim part of the wheel.

The third passageway in the adapter may be in communication with the valve, and may include an axial portion that terminates in an opening in the valve seat and that is connected to a main radial portion.

The wheel can be a two-part wheel, with the rim base and wheel mounting portion part of the inboard rim part. The opening in the rim base for the wheel mounting first passageway may be located in a circumferential furrow of the rim base. The furrow can be adjacent to and underlap the outboard rim part. The wheel assembly may also include an opening in the wheel mounting portion that extends into the first passageway, and a second valve that extends to the passageway may be mounted in the opening. The first passageway may extend in a generally radial orientation relative to the wheel.

### BRIEF DESCRIPTION OF THE DRAWINGS

The above-mentioned and other features of this invention and the manner of obtaining them will become more apparent, and the invention itself will be better understood by reference to the following description of embodiments of the present invention taken in conjunction with the accompanying drawings, wherein:

FIG. 1 is an exploded view of a wheel and an adapter and valve of a tire inflation system of the present invention;

FIG. 2 is a front view of a wheel and tire inflation system of FIG. 1 as assembled;

FIG. 3 is a cross-sectional view through the wheel and tire inflation system taken along line 3-3 in FIG. 2;

FIG. 3A is an enlarged view of the adapter and valve of a tire inflation system of the area indicated in FIG. 3;

FIG. 4 is a cross-sectional view similar to that of FIG. 3 with the tire inflation valve removed;

FIG. 5 is a cross-sectional view similar to that of FIG. 3 and including a hub mount shown in phantom lines to which the wheel is mounted;

FIG. 5A is an enlarged view of the area indicated in FIG. 5 showing the seal between the tire inflation adapter and hub; and

FIG. 5B is an enlarged view of the area indicated in FIG. 5 showing the seal between the central tire inflation adapter and wheel.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

For the purpose of promoting an understanding of the principles of the invention, reference will now be made to the embodiments illustrated in the drawings, which are described below. It will nevertheless be understood that no limitation of the scope of the invention is thereby intended. The invention includes any alterations and further modifications in the illustrated devices and described methods and further applications of the principles of the invention, which would normally occur to one skilled in the art to which the invention relates.

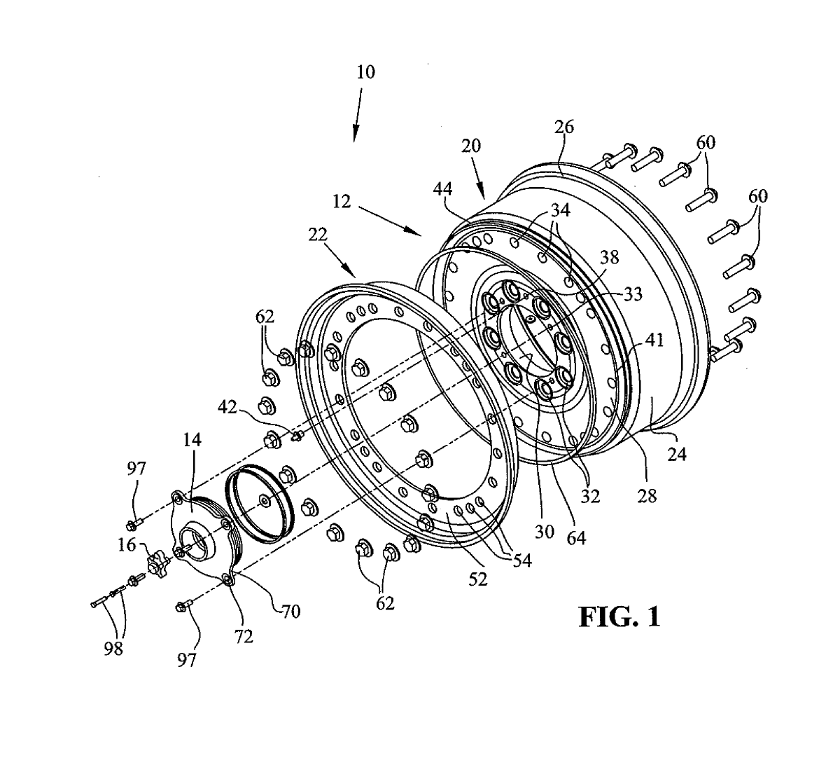

Referring to FIG. 1, in one embodiment of the invention, a wheel assembly is shown, generally indicated as 10, and includes components that form part of a tire inflation system. Wheel assembly 10 includes a wheel, generally indicated as 12, an adapter 14, and a valve or valve assembly 16.

Wheel 12 includes an inboard rim part, generally indicated as 20, and an outboard rim part, generally indicated as 22. Inboard rim part 20 has a rim base 24, an inboard tire bead retaining flange 26, and a wheel mounting portion 28. Inboard rim part 20 may be made from a steel of sufficient strength or other suitable metal. In the embodiment shown, the inboard rim part is forged or cast as a single piece; however, it may also be fabricated from one or more parts.

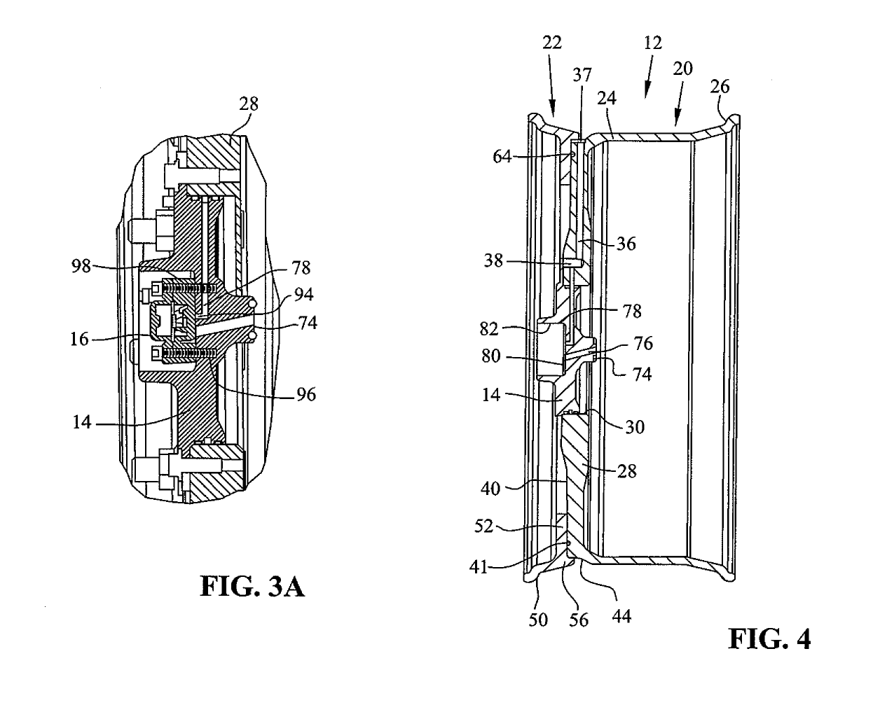

Rim base 24 extends generally parallel with an axle (not shown) to which wheel assembly 10 is configured to be mounted upon, and wheel mounting portion 28 is generally oriented in a plane substantially perpendicular to the axle and rim base 24. Wheel mounting portion 28 also includes a central opening 30, mounting holes 32 for mounting wheel assembly 10 to a vehicle, mounting holes 33, which in the embodiment shown include internal threads for mounting adapter 14, and mounting holes 34 for mounting removable outboard rim part 22 to inboard rim part 20. Wheel mounting portion 28 also includes a generally radially oriented passageway 36 (FIGS. 3 and 4) extending therethrough from central opening 30 to an opening 37 in rim base 24. It should be appreciated that radially oriented passageway 36 is intended to refer to any passageway (regardless of orientation or change in direction of the passageway) extending from the central opening 30 to an opening in or adjacent to rim base 24 for providing air to the tire mounted to the wheel assembly.

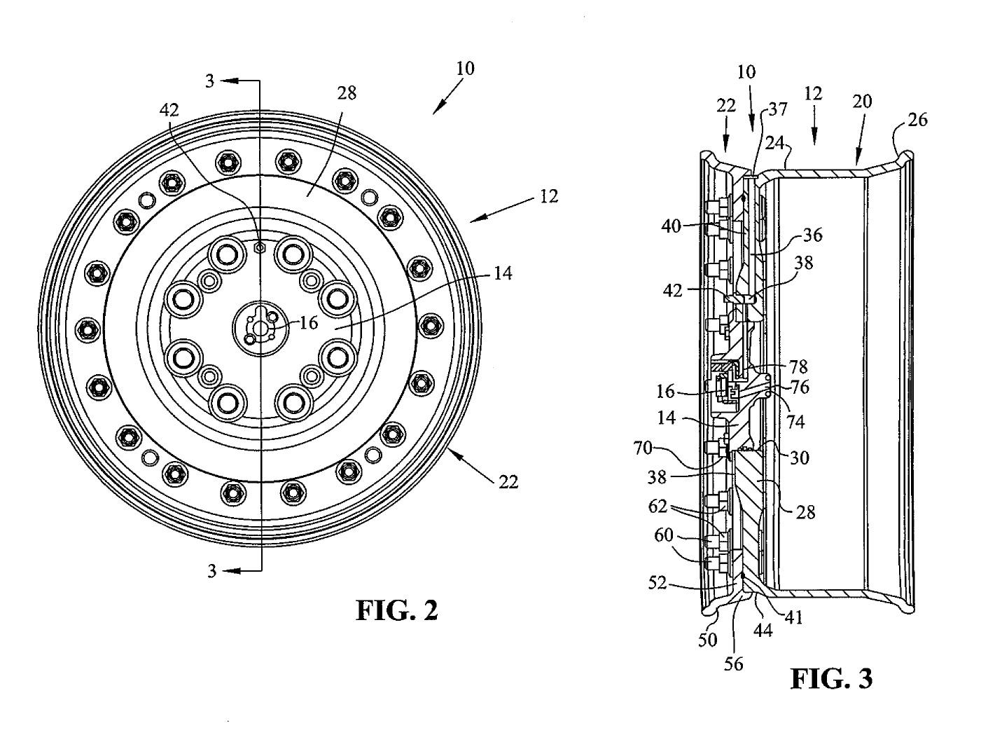

Wheel mounting portion 28 also includes an opening 38 extending from a front face 40 of the wheel mounting portion into passageway 36 (FIG. 4). An annular groove 41 (best shown in FIG. 1) is located in front face 40 for receipt of a sealing member, and opening 38 is configured to receive a second valve 42 (FIG. 2), which may be a common wheel rim value, for use in inflating the tire mounted on the wheel assembly from an external air or other gas supply. It should be appreciated that opening 38 may include internal threads so that valve 42 may include mating threads for attachment to wheel mounting portion 28.

Inboard rim part 20 may also include a circumferential furrow 44 along the outboard end of rim base 24. Circumferential furrow 44 is configured to underlap with a portion of outboard rim part 22, as described in further detail below. Additionally, radial passageway 36 may also open into rim base 24 in the circumferential furrow area.

Referring again to FIGS. 1 and 4, outboard rim part 22 may include an outboard tire bead retaining flange 50, a mounting flange 52 containing mounting holes 54 for mounting the outboard rim part 22 to inboard rim part 20, and a lip 56 configured to overlap circumferential furrow 44 when the outboard rim part is mounted to the inboard rim part.

Outboard rim part 22 is mounted to inboard rim part 20 using bolts 60 that are inserted through mounting holes 34 and 54 on the inboard and outboard rim parts, respectively, and secured with nuts 62. An O-ring or other sealing member 64 is placed between the inboard and outboard rim parts in annular groove 41.

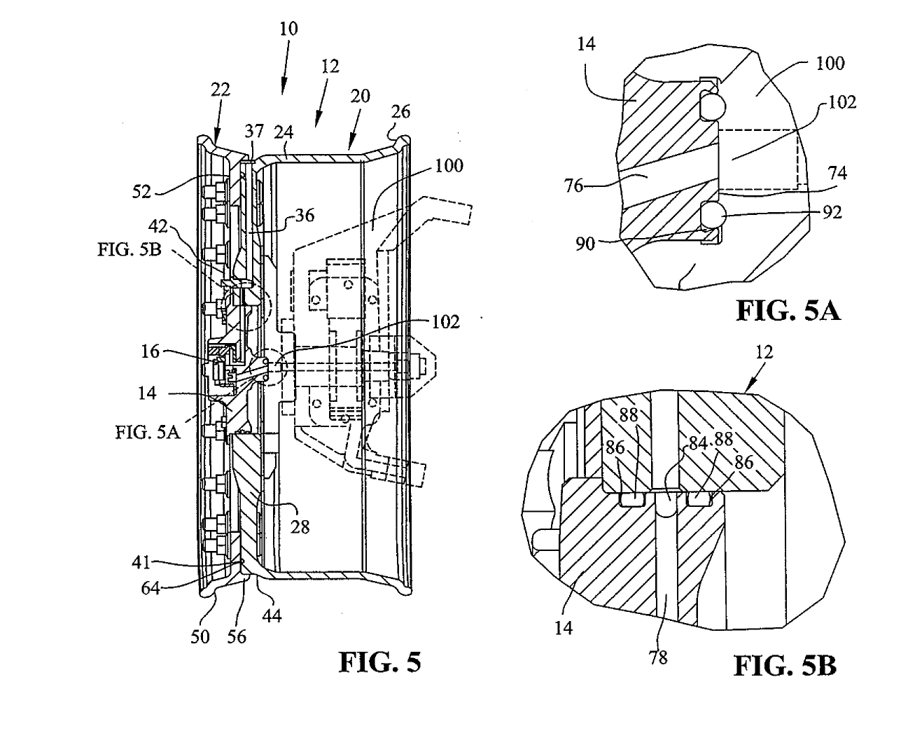

Now referring to FIGS. 1, 3, and 5-5B, adapter 14 includes a mounting flange 70 having mounting holes 72, a spindle seat 74, a generally axially extending passageway 76, and a generally radially extending passageway 78. The adapter also includes a valve seat 80 located in a recess 82 that is open toward the outboard side, as best shown in FIG. 4. Adapter 14 also includes a circumferential groove 84 (FIG. 5B) to which passageway 78 is connected. On either side of groove 84 circumferential channels 86 are located for receiving O-ring or sealing members 88. Referring to FIG. 5A, spindle seat 74 includes an annular groove 90 containing an O-ring or sealing member 92. Axial passageway 76 extends from an opening in spindle seat 74 to an opening in valve seat 80. Axial passageway 76 is intended to refer to any passageway extending from the spindle seat to the valve seat regardless of the particular orientation or change in direction thereof. Radial passageway 78 extends from circumferential groove 84 to valve seat 80 and includes a bend and a small axial section 94 (as best shown in FIG. 3A) extending into the valve seat. The radial passageway is intended to refer to any passageway extending from circumferential groove 84 to valve seat 80 regardless of orientation or change in direction of the passageway. Adapter 14 also includes holes 96, which are threaded in the embodiment shown, in valve seat 80 for mounting valve assembly 16 thereto. Adapter 14 is mounted to mounting holes 33 and wheel mounting portion 28 of inboard rim part 20 using bolts or other fasteners 97 (FIG. 1).

Valve assembly 16 is of a type known in the art and mounted to adapter 14 on valve seat 80 with screws or other known fasteners 98. Valve assembly 16 provides a one-way passage of air from axial passageway 76 into radial passageway 78, as is described further detail below.

To assemble wheel assembly 10, outboard rim part 22 is mounted to inboard rim part 20. Bolts 60 are inserted through respective mounting holes 34 and 54 in the inboard and outboard rim parts, sealing member 64 is placed in annular groove 41 to provide a seal, and the outboard rim part 22 is secured to inboard rim part 20 with nuts 62. Valve assembly 16 is installed to adapter 14 using screws 98. Valve assembly 16 allows a one-way passage of air from axial passageway 76 to radial passageway 78, which both have openings in valve seat 80 where valve assembly 16 is mounted. Valve 42 is installed in opening 38 by threading the valve into the opening. Valve 42 can be used to inflate the tire mounted on wheel assembly 10 from an external air or gas supply. Adapter 14 is mounted to mounting portion 28 of inboard rim part 20 with bolts or screws 97. Thusly mounted, a portion of adapter 14 is configured to extend into central opening 30 of mounting portion 28 with mounting flanges 70 providing a stopping limit to ensure proper installation. It should be appreciated, as circumferential groove 84 extends completely around the outer circumference, this allows the adapter to be mounted in any clockwise orientation relative to wheel 12 so long as each mounting hole 72 is aligned with a mounting hole 33 in mounting portion 28. It should also be appreciated that the adapter 14 and/or valves 16 and 42 may be removed from and replaced on wheel assembly 10 without the need to take apart the inboard and outboard rims apart.

Once assembled, wheel assembly 10 may be mounted to a spindle 100 (shown in phantom lines in FIG. 5) located on a vehicle to which the wheel assembly is mounted. Seal member 92 seals between the spindle seat 74 of adapter 14 and spindle 100 when wheel assembly 10 is mounted on the vehicle using bolts (not shown) as is common. The opening in spindle seat 74 of axial passageway 76 will align with an air outlet passageway 102 in spindle 100 that is in communication with an onboard air/gas supply or pump. The passageways align regardless of the clockwise orientation of the wheel assembly relative to the spindle. It should also be appreciated that the passageways and valves in wheel assembly 10 form a continuous pathway to allow air or gas to travel from the opening of axial passageway 76 in spindle seat 74 to opening 37 of radial passageway 36 in rim base 24/circumferential furrow 44. The continuous passageway starts with axial passageway 76, which extends to valve seat 80 and through valve assembly 16, which has an inlet opening aligned with the opening of passageway 76. Valve assembly 16 also includes an outlet opening aligned with the opening in valve seat 80 of radial passageway 78. Radial passageway 78 terminates in an opening in groove 84, whereby air can flow around adapter 14 in the groove until it encounters radial passageway 36 in inboard rim part 20. Sealing members 88 and channels 86 assure a continuous sealed passageway between groove 84 and radial passageway 36.

A tire mounted on wheel assembly 10 may be inflated in one of two ways. Air from an external compressor or other source (not shown) may be connected to an inlet of valve 42. Valve 42 has an outlet opening contained in radial passageway 36, as best shown in FIG. 3, so that air can be forced through the valve to passageway 36 and through opening 37 in furrow 44/rim base 24 to fill a tire mounted on the wheel. Valve 42 prevents the air from flowing in the reverse direction unless a release is depressed.

Alternately, an inboard air supply may be connected to radial passageway 76 and spindle seat 74 through spindle 100. Air entering axial passageway 76 will travel through the continuous passageway, as discussed above, and out opening 37 in furrow 44 to inflate the tire on wheel assembly 10. Valve assembly 16 allows the air to flow in a single direction only from axial passageway 76 and into radial passageway 78 to fill the tire; however, it prevents reverse flow of the air to keep the tire from deflating.

While the invention has been taught with specific reference to these embodiments, one skilled in the art will recognize that changes can be made in form and detail without departing from the spirit and scope of the invention. It should also be appreciated that when the term “in communication with” is used herein, it is intended to indicate a passage or pathway through which air or gas may pass. The described embodiments are to be considered, therefore, in all respects only as illustrative and not restrictive. As such, the scope of the invention is indicated by the following claims rather than by the description.

1. A wheel assembly for connection to an onboard tire inflation device, the wheel assembly including:
a multiple part wheel having an inboard rim part with a rim base and an inboard tire bead retaining flange and a removable outboard rim part having an outboard tire bead retaining flange, the inboard rim part including a wheel mounting portion and a first passageway extending therethrough from a central opening to the rim base;
an adapter mounted to the wheel mounting portion of the inboard rim part and extending at least partially into the central opening in the wheel mounting portion, the adapter including a second passageway and a third passageway; and
a valve assembly mounted to the adapter and in communication with the second passageway and the third passageway in the adapter.

2. The wheel assembly as set forth in claim 1, further including a second valve, the second valve mounted in a second opening in the wheel mounting portion of the inboard rim part, and the second valve being in communication with the first passageway in the wheel mounting portion.

3. The wheel assembly as set forth in claim 1, wherein the adapter has a circumferentially extending groove, the groove being in communication with the third passageway in the adapter and with the first passageway in the wheel mounting portion of the inboard rim part.

4. The wheel assembly as set forth in claim 3, wherein the adapter further includes first and second circumferential channels located on opposite sides of the circumferential groove, and a resilient sealing member in each of the circumferential channels.

5. The wheel assembly as set forth in claim 4, wherein the adapter has a spindle seat substantially parallel to the wheel mounting portion of the inboard rim part.

6. The wheel assembly as set forth in claim 5, wherein the axial passageway in the adapter has an opening in the spindle seat.

7. The wheel assembly as set forth in claim 6, wherein the spindle seat has an annular groove extending around an opening of the second passageway and a sealing member in the annular groove.

8. The wheel assembly as set forth in claim 6, wherein a continuous pathway is formed between the opening in the spindle seat and an opening of the first passageway in the rim base of the inboard rim part.

9. The wheel assembly as set forth in claim 8, wherein the valve assembly mounted to the adapter allows air to flow from the opening in the spindle seat to the opening in the rim base.

10. The wheel assembly as set forth in claim 9, wherein the valve assembly restricts airflow in the opposite direction.

11. The wheel assembly as set forth in claim 1, wherein the third passageway in the adapter includes a portion generally perpendicular to a main portion and that terminates at an opening where the valve assembly is mounted to the adapter.

12. The wheel assembly as set forth in claim 11, wherein the adapter includes a mounting flange and an axial recess configured to receive the valve assembly.

13. The wheel assembly as set forth in claim 8, wherein the continuous pathway extends through the wheel assembly regardless of the radial orientation in which the adapter is mounted relative to the wheel mounting portion.

14. A wheel assembly for connection to an onboard tire inflation device, the wheel assembly including:
a wheel having a rim base, an inboard tire bead retaining flange, an outboard tire bead retaining flange, and a wheel mounting portion having a central opening and a first passageway therethrough;
an adapter mounted to the wheel mounting portion and extending at least partially into the central opening, the adapter including a second passageway and a third passageway, the second passageway terminating in an opening in a spindle seat, the spindle seat oriented substantially parallel to the wheel mounting portion of the wheel; and
a valve mounted to the adapter, the valve being in communication with the second passageway and the third passageway in the adapter.

15. The wheel assembly as set forth in claim 14, wherein the first passageway extends between the central opening and the rim base.

16. The wheel assembly as set forth in claim 15, including a second valve mounted in an opening in the wheel mounting portion of the wheel, the second valve extending into the first passageway in the wheel mounting portion.

17. The wheel assembly as set forth in claim 16, wherein the spindle seat on the adapter has an annular groove therein and a sealing member in the annular groove that extends around the opening in the spindle seat.

18. The wheel assembly as set forth in claim 17, wherein the adapter includes a circumferential groove.

19. The wheel assembly as set forth in claim 18, wherein the third passageway in the adapter is in communication with the groove.

20. The wheel assembly as set forth in claim 19, including a pair of circumferential channels extending around the adapter, a channel on each side of the groove, and a sealing member located in each channel.

21. The wheel assembly as set forth in claim 19, wherein the passageways form a continuous airflow pathway from the opening of the second passageway in the spindle seat of the adapter to an opening in the rim base at an end of the first passageway in the wheel mounting portion.

22. A wheel assembly for connection to an onboard tire inflation device, the wheel assembly including:
a wheel including an inboard rim part and an outboard rim part, the wheel further including a rim base on at least one of the parts and a wheel mounting portion, the wheel mounting portion including a first passageway extending from an inner opening in the wheel mounting portion to an opening in the rim base;
an adapter mounted to the wheel mounting portion of the wheel and extending at least partially into the inner opening of the wheel, the adapter including a second passageway, a third passageway terminating in an opening, a circumferential groove in communication with the radial passageway, and a valve seat; and
a valve mounted to the valve seat.

23. The wheel assembly as set forth in claim 22, wherein the adapter includes a spindle seat and the end of the axial passageway opposite the valve seat terminates in an opening in the spindle seat.

24. The wheel assembly as set forth in claim 23, wherein the spindle seat has a seal member in an annular groove around the opening.

25. The wheel assembly as set forth in claim 22, wherein the adapter includes a mounting flange configured to mount the adapter to the wheel mounting portion of the wheel, the flange extending generally parallel with the wheel mounting portion of the wheel.

26. The wheel assembly as set forth in claim 25, wherein the adapter includes a recess therein, the valve seat being at the bottom of the recess and the recess being open toward the outboard rim part of the wheel.

27. The wheel assembly as set forth in claim 22, wherein the second passageway in the adapter is in communication with the valve.

28. The wheel assembly as set forth in claim 27, wherein the third passageway in the adapter includes an axial portion terminating in an opening in the valve seat.

29. The wheel assembly as set forth in claim 22, wherein the wheel is a two-part wheel, and the rim base and wheel mounting portion are part of the inboard rim part.

30. The wheel assembly as set forth in claim 29, wherein the opening in the rim base for the wheel mounting portion first passageway is located in a circumferential furrow of the rim base, the furrow being adjacent to and underlapping the outboard rim art.

31. The wheel assembly as set forth in claim 30, further including an opening in the wheel mounting portion and extending into the first passageway, and a second valve mounted in the opening in communication with the first passageway.

32. The wheel assembly as set forth in claim 31, wherein the first passageway in the wheel mounting portion extends in a generally radial orientation of the wheel.
